(19) United States
(12) Patent Application Publication
(10) Pub. No.: US 2024/0419059 A1
(43) Pub. Date: Dec. 19, 2024

(54) PROJECTION DEVICE, CASING STRUCTURE AND PROTECTIVE MESH STRUCTURE

(71) Applicant: Coretronic Projection (Kunshan) Corporation, Jiangsu (CN)

(72) Inventors: GANG LI, Jiangsu (CN); CAIPING GU, Jiangsu (CN)

(73) Assignee: Coretronic Projection (Kunshan) Corporation, Jiangsu (CN)

(21) Appl. No.: 18/679,421

(22) Filed: May 30, 2024

(30) Foreign Application Priority Data
Jun. 16, 2023 (CN) 202310718197.1

(51) Int. Cl. G03B 21/14

(52) U.S. Cl. CPC G03B 21/145

(57) ABSTRACT

A projection device includes a casing structure and a protective mesh structure. The casing structure includes a casing, at least one position-limiting structure, and at least one stopper structure. At least one position-limiting groove is formed between a side cover of the casing and the position-limiting structure. The stopper structure is connected to the side cover and protrudes toward a containing space inside the casing. The protective mesh structure includes a protective mesh body and at least one protective mesh position-limiting portion. The protective mesh body is adapted to be installed in the containing space and at least partially limited in the position-limiting groove. The protective mesh position-limiting portion is connected to the protective mesh body and leans against the stopper structure of the casing structure, so as to prevent the protective mesh structure from being separated from the casing structure.

### CROSS-REFERENCE TO RELATED APPLICATION

This application claims the priority benefit of China application serial no. 202310718197.1, filed on Jun. 16, 2023. The entirety of the above-mentioned patent application is hereby incorporated by reference herein and made a part of this specification.

### BACKGROUND

### Technical Field

The disclosure relates to an optical device and a casing structure and a protective mesh structure thereof, and particularly relates to a projection device and a casing structure and a protective mesh structure thereof.

### Description of Related Art

The current projection devices are generally placed horizontally on a table or hung on a ceiling. Some of the projection devices may project image beams to a projection target (such as a wall or projection screen) when casings of the projection devices are tilted or flipped according to the user's needs. However, when the projection device is in a tilted or flipped state, an air inlet or outlet thereof may probably face upward, making it easy for foreign objects to pass through the air inlet or outlet and fall into the projection device. In order to overcome such problem, the current projection device installs a protective mesh inside the air inlet or outlet. This protective mesh is usually fixed inside the projection device in advance by means of hot melting, screw locking or clamping, and users cannot selectively disassemble and install the protective mesh, which makes the projection device and the protective mesh inflexible in use.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The disclosure is directed to a projection device and a casing structure and a protective mesh structure, allowing users to selectively disassemble and install the protective mesh on the projection device according to actual needs.

Additional aspects and advantages of the present disclosure will be set forth in the description of the techniques disclosed in the present disclosure.

In order to achieve one or a portion of or all of the objects or other objects, an embodiment of the disclosure provides a projection device adapted to selectively install a protective mesh structure. The projection device includes a casing structure and the protective mesh structure. The casing structure includes a casing, at least one position-limiting structure and at least one stopper structure. The casing includes a plurality of side covers, and the side covers form a containing space. The position-limiting structure is connected to one side cover of the plurality of side covers and located in the containing space, and at least one position-limiting groove is formed between the side cover and the position-limiting structure. The stopper structure is connected to the side cover and protrudes toward the containing space, and the position-limiting structure and the stopper structure are respectively connected to an inner surface of the side cover. The protective mesh structure includes a protective mesh body and at least one protective mesh position-limiting portion. The protective mesh body is adapted to be installed in the containing space, and at least a part of the protective mesh body is limited in the position-limiting groove. The protective mesh position-limiting portion is connected to the protective mesh body and leans against the stopper structure of the casing structure, so as to prevent the protective mesh structure from being separated from the casing structure.

In order to achieve one or a portion of or all of the objects or other objects, an embodiment of the disclosure provides a casing structure adapted to selectively install a protective mesh structure. The casing structure includes a casing, at least one position-limiting structure and at least one stopper structure. The casing includes a plurality of side covers, and the side covers form a containing space. The position-limiting structure is connected to one side cover of the plurality of side covers and located in the containing space. At least one position-limiting groove is formed between the side cover and the position-limiting structure. The position-limiting groove is adapted to limit the protective mesh structure. The stopper structure is connected to the side cover and protrudes toward the containing space, the position-limiting structure and the stopper structure are respectively connected to an inner surface of the side cover, and the stopper structure is adapted to prevent the protective mesh structure from being separated from the casing structure.

In order to achieve one or a portion of or all of the objects or other objects, an embodiment of the disclosure provides a protective mesh structure, adapted to be selectively installed in a casing structure of a projection device. The protective mesh structure includes a protective mesh body and at least one protective mesh position-limiting portion. The protective mesh body is adapted to be installed in a containing space of the casing structure. One end of the protective mesh position-limiting portion is connected to the protective mesh body, the protective mesh position-limiting portion is bent relative to the protective mesh body, and the protective mesh position-limiting portion is adapted to lean against a stopper structure of the casing structure.

Based on the above description, embodiments of the disclosure have at least one of the following advantages or effects. In the projection device according to the embodiment of the disclosure, the side cover of the casing of the casing structure has the position-limiting structure and the stopper structure, so that the protective mesh structure is well installed to the casing based on position-limiting of the position-limiting structure to the protective mesh structure, and the protective mesh structure is prevented from being separated from the casing structure through stopping of the stopper structure to the protective mesh structure. Accordingly, the user may easily disassemble and install the protective mesh structure according to actual needs, making the projection device and the protective mesh structure thereof highly flexible in use.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a projection device according to an embodiment of the disclosure.

FIG. 2 is a bottom view of the projection device of FIG. 1.

FIG. 3 is an exploded three-dimensional view of the projection device of FIG. 2.

FIG. 4 is a partial structural three-dimensional view of the projection device of FIG. 2.

FIG. 5 is a partial structural bottom view of the projection device of FIG. 2.

FIG. 6 is a partial structural side view of the projection device of FIG. 2.

FIG. 7 is a top view of a protective mesh structure of FIG. 4.

FIG. 8 is a partial structural three-dimensional view of the projection device of FIG. 2.

FIG. 9 illustrates removing of a protective mesh structure of FIG. 8.

FIG. 10 is a partial enlarged schematic diagram of a protective mesh structure of FIG. 3.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

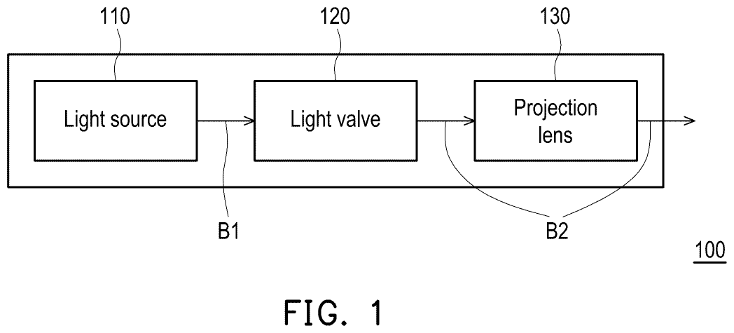

FIG. 1 is a schematic diagram of a projection device according to an embodiment of the disclosure. Referring to FIG. 1, the projection device 100 (e.g. the projector) of the embodiment includes a light source 110, a light valve 120 and a projection lens 130. The light source 110 is configured to provide an illumination beam B1. The light valve 120 is disposed on a transmission path of the illumination beam B1 and is configured to convert the illumination beam B1 into an image beam B2. The projection lens 130 is disposed on a transmission path of the image beam B2, and the projection lens 130 is configured to project the image beam B2 out of the projection device 100 and onto a projection target, such as a screen or a wall.

In the embodiment, the light source 110 includes at least one light-emitting element. The light source 110 may also be equipped with at least one of a wavelength conversion element (e.g. the phosphor wheel), a light uniformizing element (e.g. the rod), a filter element (e.g. the filter wheel), and at least one light guide element (e.g. the mirror) to provide light beams of different wavelengths as a source of the illumination beam B1. The at least one light-emitting element may be a light emitting diode (LED), a laser diode (LD), or a combination thereof, and the disclosure does not limit a type or form of the light source 110.

The light valve 120 may be a reflective light modulator such as a liquid crystal on silicon panel or a digital micro-mirror device. Alternatively, the light valve 120 may be a transmissive light modulator such as a transparent liquid crystal panel, an electro-optical modulator, a magneto-optic modulator or an acousto-optic modulator. The disclosure does not limit a pattern and type of the light valve 120.

The projection lens 130 may include a combination of one or more optical lenses with refractive power, such as various combinations of non-planar lenses including biconcave lenses, biconvex lenses, concavo-convex lenses, convexo-concave lenses, plano-convex lenses plano-concave lenses, etc. In an embodiment, the projection lens 130 may further include a planar optical lens to project the image beam B2 out of the projection device 100 in a reflective manner. The disclosure does not limit a pattern and type of the projection lens 130.

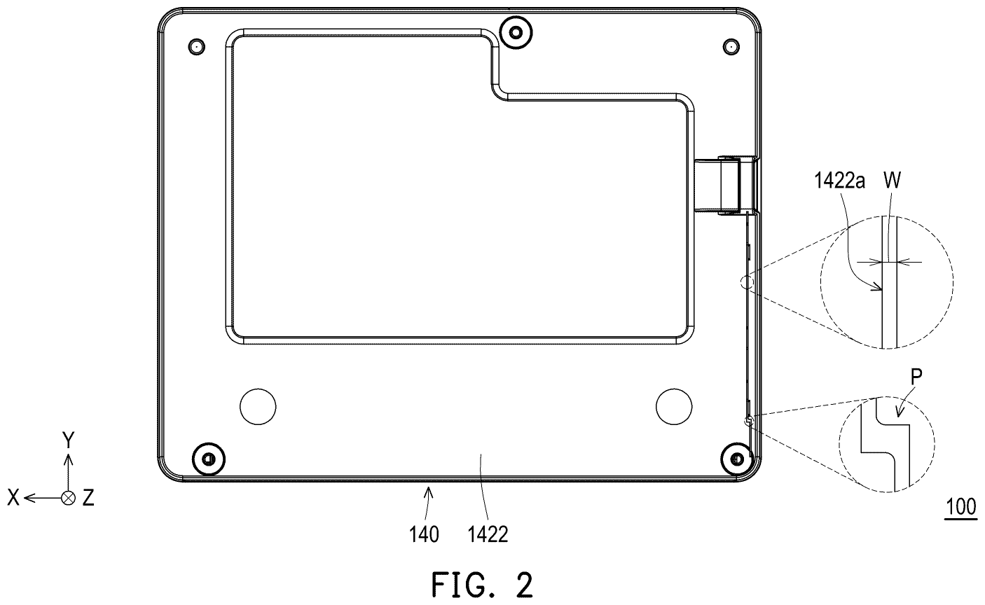

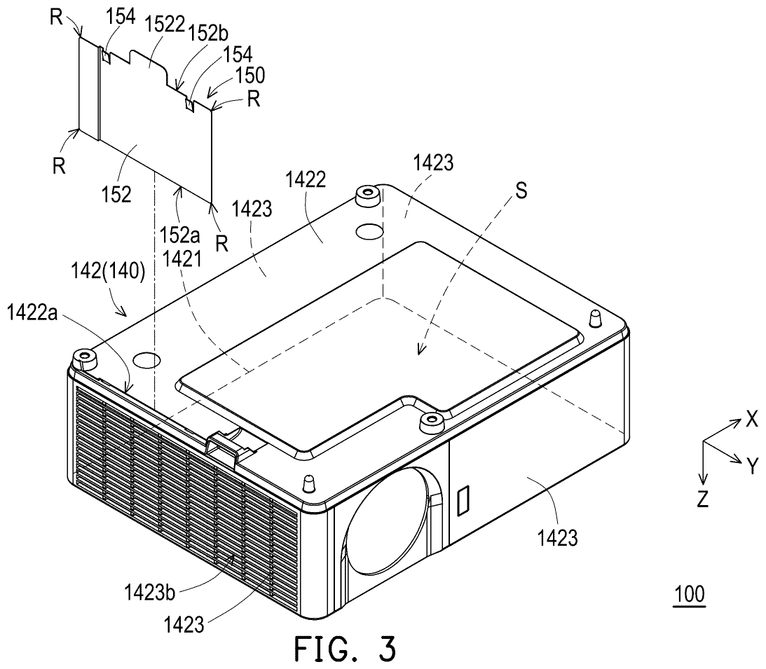

FIG. 2 is a bottom view of the projection device of FIG. 1, which illustrates axial directions X, Y, and Z. FIG. 3 is an exploded three-dimensional view of the projection device of FIG. 2. Referring to FIG. 2 and FIG. 3, the projection device 100 of the embodiment includes a casing structure 140 and a protective mesh structure 150. The protective mesh structure 150 is a detachable protective mesh structure, that is, the protective mesh structure 150 may be selectively installed on the projection device 100. The protective mesh structure 150 is a protective mesh. The casing structure 140 includes a casing 142. The casing 142 includes a top cover 1421, a bottom cover 1422 and a plurality of side covers 1423. The top cover 1421, the bottom cover 1422 and the plurality of side covers 1423 are connected to form a containing space S, and the light source 110, the light valve 120 and the projection lens 130 shown in 1 are arranged in the containing space S. The casing 142 has an installation slot 1422a (e.g. a slot) on the bottom cover 1422, and the protective mesh structure 150 is adapted to be inserted into the containing space S from the installation slot 1422a along the axial direction Z.

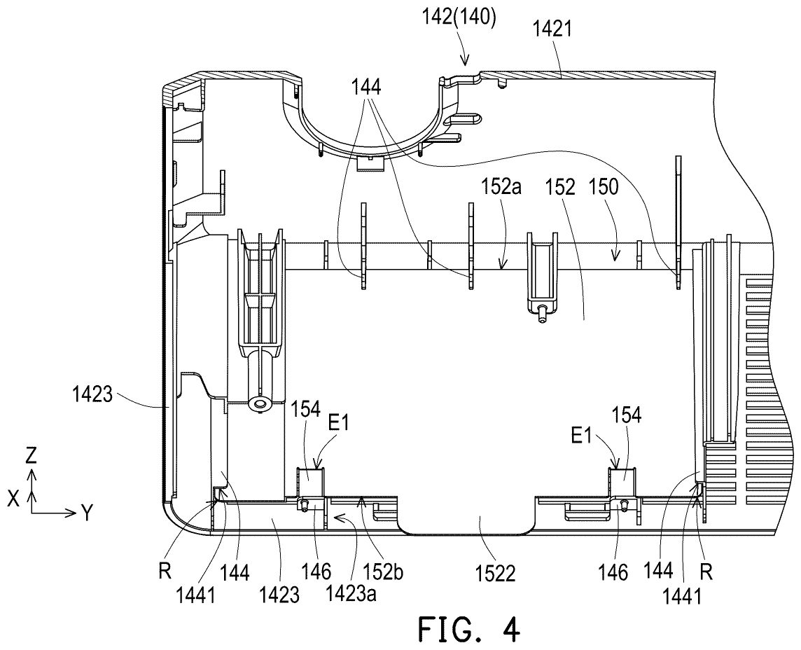

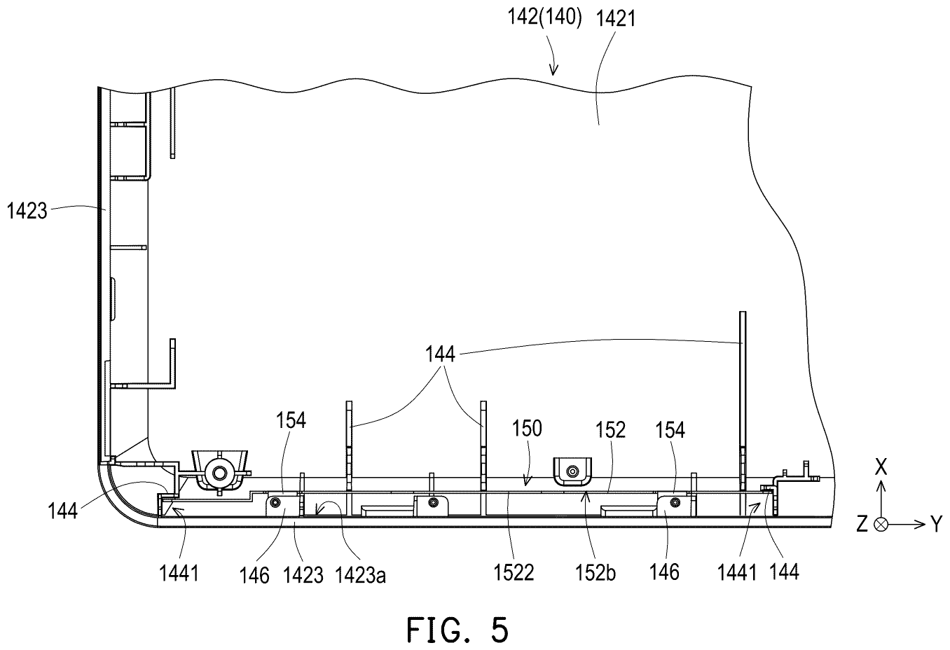

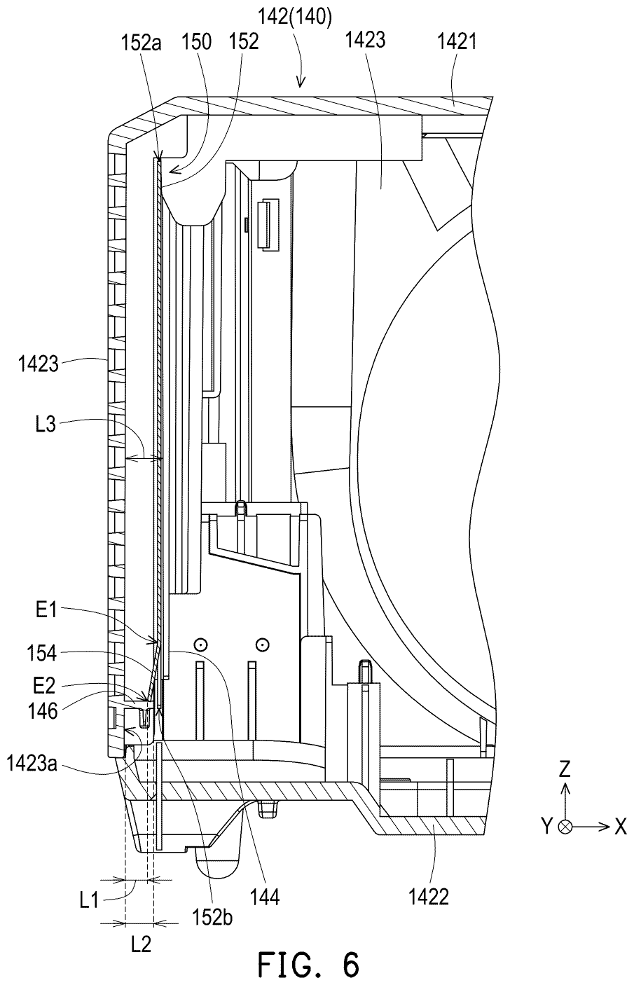

FIG. 4 is a partial structural three-dimensional view of the projection device of FIG. 2. FIG. 5 is a partial structural bottom view of the projection device of FIG. 2. FIG. 6 is a partial structural side view of the projection device of FIG. 2. Referring to FIGS. 4 to 6, the casing structure 140 of the embodiment further includes at least one position-limiting structure 144 (a plurality of the position-limiting structures 144 are shown) and at least one stopper structure 146 (a plurality of the stopper structures 146 are shown). The position-limiting structure 144 is connected to one side cover 1423 of the plurality of side covers 1423 and is located in the containing space S, and a position-limiting groove 1441 is formed between the side cover 1423 and each position-limiting structure 144. The position-limiting structure 144 is, for example, a protuberance. As shown in FIG. 5, the stopper structure 146 is connected to the side cover 1423 and protrudes toward the containing space S along the axial direction X. The stopper structure 146 is, for example, a stopper. The position-limiting structure 144 and the stopper structure 146 are respectively connected to a same inner surface 1423a of the side cover 1423. The position-limiting structure 144 and the stopper structure 146 are both connected to the same side cover 1423.

The protective mesh structure 150 includes a protective mesh body 152 and at least one protective mesh position-limiting portion 154 (two protective mesh position-limiting portions 154 are shown in the figure). The protective mesh body 152 is adapted to be installed in the containing space S, and at least a part of the protective mesh body 152 is limited in the position-limiting groove 1441. The protective mesh position-limiting portion 154 is connected to the protective mesh body 152 and leans against the stopper structure 146 of the casing structure 140 to prevent the protective mesh structure 150 from being separated from the casing structure 140.

As mentioned above, the side cover 1423 of the casing 142 of the embodiment has the position-limiting structure 144 and the stopper structure 146. Through position-limiting of the position-limiting structure 144 to the protective mesh structure 150, the protective mesh structure 150 may be well installed to the casing 142, and through stopping of the stopper structure 146 to the protective mesh structure 150, the protective mesh structure 150 is prevented from being separated from the casing structure 140. Accordingly, the user may easily disassemble and assemble the protective mesh structure 150 according to actual needs, so that the projection device 100 and the protective mesh structure 150 thereof have high flexibility in use.

For example, when the user wants to flip the projection device 100 for projection in a portrait mode (Portrait Mode), and an air inlet (or air outlet) 1423b of the side cover 1423 of the casing 142 of the casing structure 140 faces upward, i.e., when the side cover 1423 with the air inlet (or air outlet) 1423b is configured as a top surface of the casing 142, for example, when the axial direction X in FIG. 3 is parallel to a direction of gravity. The user may install the protective mesh structure 150 on the casing 142 as mentioned above to prevent foreign objects from falling into the projection device 100 through the air inlet (or air outlet) 1423b. On the contrary, when the user wants to use the projection device 100 for projection in a horizontal mode so that the air inlet (or air outlet) 1423b of the side cover 1423 does not face upward, for example, when the axial direction Z in FIG. 3 is parallel to the direction of gravity, the user may disassemble the protective mesh structure 150 from the casing 142. Based on the above design of the embodiment, when users purchase the projection device 100, they may selectively purchase the protective mesh structure 150 or not purchase the protective mesh structure 150 according to their needs.

In the embodiment, a width W (indicated in FIG. 2) of the installation slot 1422a of the casing 142 is, for example, greater than 0 mm and less than or equal to 1 mm. Accordingly, the installation slot 1422a will not affect a structural strength of the casing 142 due to excessive volume, and foreign matter may be prevented from entering the casing 142 through the installation slot 1422a. Configuration of the installation slot 1422a allows the protective mesh structure 150 to be installed on the projection device 100 without affecting an appearance of the projection device 100. In other embodiments, the installation slot 1422a may also be provided on the top cover 1421 of the casing 142.

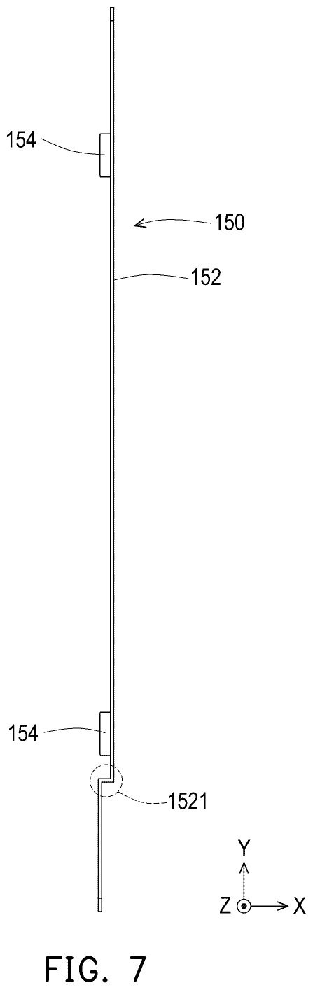

FIG. 7 is a top view of the protective mesh structure of FIG. 4. Referring to FIG. 2 and FIG. 7, the protective mesh body 152 of the embodiment has a stepped structure 1521, and the installation slot 1422a has a positioning unit P corresponding to the stepped structure 1521. A partial section of the installation slot 1422a is in a stepped shape corresponding to the stepped structure 1521 to form the positioning unit P. The positioning unit P may be, for example, a positioning rod, a positioning protrusion, a positioning block, or other positioning structures. Accordingly, the mutual cooperation (installation) between the protective mesh body 152 and the installation slot 1422a is directional, thereby achieving a fool-proof effect and preventing the user from installing the protective mesh structure 150 in a wrong direction.

Referring to FIG. 3 and FIG. 4, a peripheral edge of the protective mesh body 152 of the embodiment has an arc-shaped chamfer R to prevent discomfort caused by the user touching sharp corners when taking the protective mesh structure 150. The protective mesh body 152 has a first end 152a and a second end 152b opposite to each other. The protective mesh body 152 is adapted to be inserted into the containing space S from the first end 152a. The protective mesh structure 150 further includes a hand-held portion 1522 connected to the second end 152b of the protective mesh body 152, and the hand-held portion 1522 is used for the user to hold to facilitate performing disassembling and assembling of the protective mesh structure 150. The hand-held portion 1522 is, for example, a protrusion.

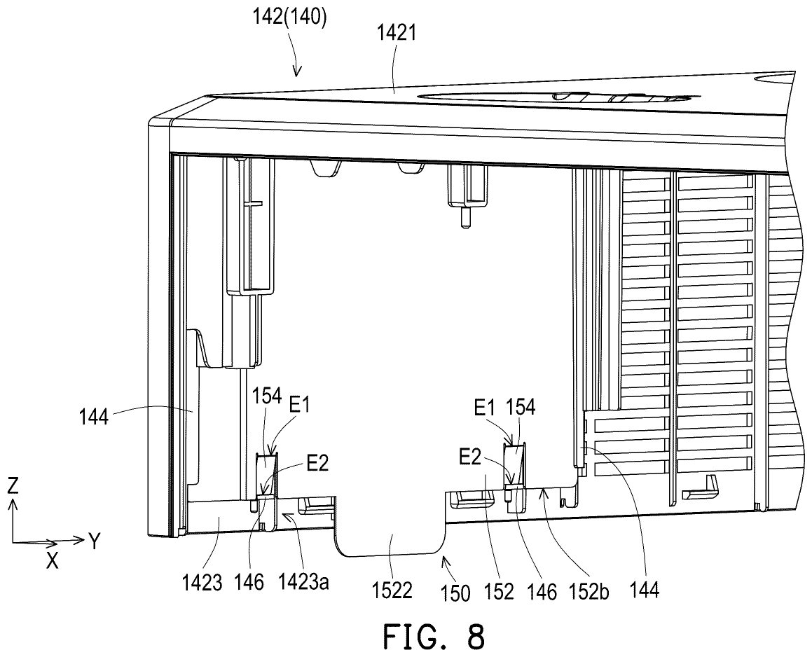

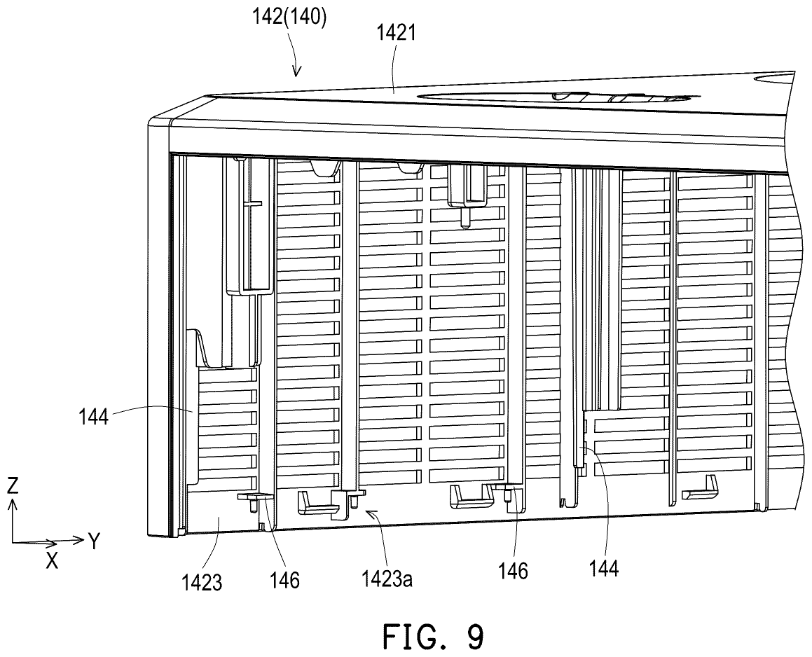

The structure of the protective mesh position-limiting portion 154 of the embodiment will be described in more detail below. FIG. 8 is a partial structural three-dimensional view of the projection device of FIG. 2. FIG. 9 illustrates removing of the protective mesh structure of FIG. 8. Referring to FIG. 8 and FIG. 9, one end of the protective mesh position-limiting portion 154 of the embodiment is connected to the protective net body 152. The protective mesh position-limiting portion 154 is bent relative to the protective mesh body 152. When the protective mesh structure 150 is installed on the casing structure 140, the protective mesh position-limiting portion 154 is bent relative to the protective mesh position-limiting body 152 toward the side cover 1423 connected to the positon-limiting structure 144 and the stopper structure 146 and leans against the stopper structure 146. The protective mesh position-limiting portion 154 has a connecting end E1 and a free end E2. The connecting end E1 is connected to the protective mesh body 152, and the stopper structure 146 protrudes from the inner surface 1423a of the side cover 1423 of the casing 142 to stop the free end E2 of the protective mesh position-limiting portion 154.

In the embodiment, the protective mesh structure 150 and the protective mesh position-limiting portion 154 thereof are, for example, made of an elastic material (such as plastic). Therefore, during the process of installing or disassembling the protective mesh structure 150 along the axial direction Z, the protective mesh position-limiting portion 154 may cross over the stopper structure 146 through elastic deformation, so that the protective mesh structure 150 may be installed or disassembled smoothly.

Referring to FIG. 6, in the embodiment, a distance L1 between the free end E2 of the protective mesh position-limiting portion 154 and the inner surface 1423a of the side cover 1423 is less than a protruding length L2 of the stopper structure 146 from the inner surface 1423a, and the inner surface 1423a is connected to the position-limiting structure 144 and the stopper structure 146, such that the stopper structure 146 may smoothly stop the free end E2 of the protective mesh position-limiting portion 154. A distance L3 between the position-limiting structure 144 and the inner surface 1423a is greater than the protruding length L2 of the stopper structure 146 from the inner surface 1423a, so that the position-limiting structure 144 may smoothly limit the protective mesh structure 150 in the axial direction X to avoid deflection of the protective mesh structure 150 during installation.

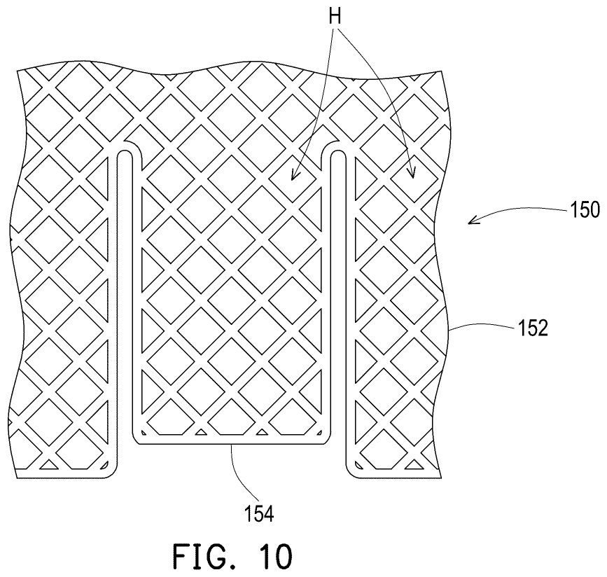

FIG. 10 is a partial enlarged schematic diagram of the protective mesh structure of FIG. 3. Although the protective mesh structure 150 in FIG. 3 to FIG. 9 does not show its mesh holes, in fact, at least most areas of the protective mesh structure 150 have a plurality of mesh holes H as shown in FIG. 10, so as to achieve a breathable effect. In this way, the protective mesh structure 150 of the embodiment will not affect a heat dissipation effect of the projection device 100 after being installed on the projection device 100. The protective mesh position-limiting portion 154 is, for example, formed by cutting the protective mesh body 152 and also has the mesh holes H. A length of the mesh hole H in any direction is, for example, less than 5 mm.

In summary, the embodiments of the disclosure have at least one of the following advantages or effects. In the projection device according to the embodiment of the disclosure, the side cover of the casing has the position-limiting structure and the stopper structure, so that the protective mesh structure is well installed to the casing based on position-limiting of the position-limiting structure to the protective mesh structure, and the protective mesh structure is prevented from being separated from the casing structure through stopping of the stopper structure to the protective mesh structure. Accordingly, the user may easily disassemble and install the protective mesh structure according to actual needs, making the projection device and the protective mesh structure thereof highly flexible in use.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection device, adapted to selectively install a protective mesh structure, the projection device comprising:
a casing structure, comprising:
a casing, comprising a plurality of side covers, wherein the side covers form a containing space;
at least one position-limiting structure, connected to one side cover of the plurality of side covers and located in the containing space, wherein at least one position-limiting groove is formed between the side cover and the at least one position-limiting structure; and
at least one stopper structure, connected to the side cover and protruding toward the containing space, wherein the at least one position-limiting structure and the at least one stopper structure are respectively connected to an inner surface of the side cover; and
the protective mesh structure, comprising:
a protective mesh body, adapted to be installed in the containing space, wherein at least a part of the protective mesh body is limited in the at least one position-limiting groove; and
at least one protective mesh position-limiting portion, connected to the protective mesh body and leaning against the at least one stopper structure of the casing structure, so as to prevent the protective mesh structure from being separated from the casing structure.

2. The projection device as claimed in claim 1, wherein the casing has an installation slot, and the protective mesh structure is adapted to be inserted into the containing space from the installation slot.

3. The projection device as claimed in claim 2, wherein a width of the installation slot is greater than 0 mm and less than or equal to 1 mm.

4. The projection device as claimed in claim 2, wherein the protective mesh body has a stepped structure, and the installation slot has a positioning unit corresponding to the stepped structure.

5. The projection device as claimed in claim 1, wherein a peripheral edge of the protective mesh body has an arc-shaped chamfer.

6. The projection device as claimed in claim 1, wherein the protective mesh body has a first end and a second end opposite to each other, the protective mesh body is adapted to be inserted into the containing space from the first end, the protective mesh structure further comprises a hand-held portion, and the hand-held portion is connected to the second end.

7. The projection device as claimed in claim 1, wherein one end of the at least one protective mesh position-limiting portion is connected to the protective mesh body, and the at least one protective mesh position-limiting portion is bent toward the side cover relative to the protective mesh body and leans against the at least one stopper structure.

8. The projection device as claimed in claim 1, wherein the at least one protective mesh position-limiting portion has a connecting end and a free end, the connecting end is connected to the protective mesh body, the at least one stopper structure protrudes from the inner surface of the casing, and a distance between the free end and the inner surface is less than a protruding length of the stopper structure from the inner surface.

9. The projection device as claimed in claim 1, wherein a distance between the at least one position-limiting structure and the inner surface is greater than a protruding length of the at least one stopper structure from the inner surface.

10. A casing structure, adapted to selectively install a protective mesh structure, the casing structure comprising:
a casing, comprising a plurality of side covers, wherein the side covers form a containing space;
at least one position-limiting structure, connected to one side cover of the plurality of side covers and located in the containing space, wherein at least one position-limiting groove is formed between the side cover and the at least one position-limiting structure, and the at least one position-limiting groove is adapted to limit the protective mesh structure; and
at least one stopper structure, connected to the side cover and protruding toward the containing space, wherein the at least one position-limiting structure and the at least one stopper structure are respectively connected to an inner surface of the side cover, and the at least one stopper structure is adapted to prevent the protective mesh structure from being separated from the casing structure.

11. The casing structure as claimed in claim 10, wherein the casing has an installation slot, and the protective mesh structure is adapted to be inserted into the containing space from the installation slot.

12. The casing structure as claimed in claim 11, wherein a width of the installation slot is greater than 0 mm and less than or equal to 1 mm.

13. The casing structure as claimed in claim 11, wherein the installation slot has a positioning unit corresponding to a stepped structure of a protective mesh body.

14. The casing structure as claimed in claim 10, wherein a distance between the at least one position-limiting structure and the inner surface is greater than a protruding length of the at least one stopper structure from the inner surface.

15. A protective mesh structure, adapted to be selectively installed in a casing structure of a projection device, the protective mesh structure comprising:
a protective mesh body, adapted to be installed in a containing space of the casing structure; and
at least one protective mesh position-limiting portion, wherein one end of the at least one protective mesh position-limiting portion is connected to the protective mesh body, the at least one protective mesh position-limiting portion is bent relative to the protective mesh body, and the at least one protective mesh position-limiting portion is adapted to lean against at least one stopper structure of the casing structure.

16. The protective mesh structure as claimed in claim 15, wherein the protective mesh body has a stepped structure, and the stepped structure is adapted to be arranged on a positioning unit of an installation slot of the casing structure.

17. The protective mesh structure as claimed in claim 15, wherein a peripheral edge of the protective mesh body has an arc-shaped chamfer.

18. The protective mesh structure as claimed in claim 15, wherein the protective mesh body has a first end and a second end opposite to each other, the protective mesh body is adapted to be inserted into the containing space from the first end, the protective mesh structure further comprises a hand-held portion, and the hand-held portion is connected to the second end.

19. The protective mesh structure as claimed in claim 15, wherein the at least one protective mesh position-limiting portion has a connecting end and a free end, the connecting end is connected to the protective mesh body, and a distance between the free end and an inner surface is less than a protruding length of the at least one stopper structure from the inner surface.
